(19) United States
(12) Patent Application Publication
(10) Pub. No.: US 2007/0220369 A1
(43) Pub. Date: Sep. 20, 2007

(54) Fault isolation and availability mechanism for multi-processor system

(75) Inventors: Camil Fayad, Poughkeepsie, NY (US); John K. Li, Woodstock, NY (US); Siegfried Sutter, Boeblingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: International Business Machines Corporation, Armonk, NY (US)

(21) Appl. No.: 11/358,174

(22) Filed: Feb. 21, 2006

(51) Int. Cl. G06F 11/00

(52) U.S. Cl. 714/48

(57) ABSTRACT

A method and apparatus are provided for identifying a defective processor of a plurality of processors of a multi-processor system. In such method, a first command is submitted to a first processor and to a second processor within the multi-processor system. The first command is executed by each of the first and second processors. A first result of executing the first command by the first processor is compared with a second result of executing the second command by the second processor. A hard error is indicated when the first result does not match the second result. To further isolate a fault within the system, commands are submitted to different pairings of processors and the results are compared to isolate a faulty processor from among them.

### BACKGROUND OF THE INVENTION

The present invention relates to fault isolation mechanisms used in detection of data integrity problems in secure environments.

The ever increasing popularity of initiating and completing business transactions over communication networks, such as the internet, has provided an immediate need to provide security for some of these transactions. Providing secure environments that are free of threat of third party data interception and data tampering are particularly important in business transactions that involve transfer of financial information. Such security attacks can either be physical or can be program or algorithmic driven in nature. Physical or hardware attacks can be more easily identifiable and thwarted by installing measures that for example, detect attempts at physical intrusions, including electrical intrusions. Algorithmic and software attacks in general are more difficult to prevent and detect.

In recent years, cryptography has become a popular means of ensuring algorithmic security for such transactions. A key aspect of cryptography is the manner that cryptography code can be used in detecting problems of algorithmic nature caused by different forms of security attacks. Cryptographic keys of ever increasing length, for example, can be used to outmatch the increasing power of data processing systems utilized to break the cryptographic code. In addition, cryptographic code can also be used in initiating preventative measures that lead to trusted transactions. Such preventative measures range from providing methods of authentication to that of verification, both of data and even electronic signatures, all of which are designed to promote and improve remote and on-line business transactions.

In business transactions of highly sensitive nature, transaction completion requires the highest level of afforded security. This highest level of security is defined by Federal Information Processing Standards (FIPS). In Federal Information Processing Standards (FIPS) publication 140-2 issued May 25, 2001 which supersedes FIPS PUB 140-1 dated Jan. 11, 1994 standards for four levels of security are discussed, ranging from the lowest level or Level I, to the highest level or Level 4 as relating to data encryption. An example of a Security Level I cryptographic module is described as being represented by a personal computer (PC) encryption board. Security Level 2 requires that any evidence of an attempt at physical tampering be present. Security Level 3 requires identity based authentication mechanisms and Security Level 4 is provides for a complete envelope of protection around the cryptographic module.

Providing the highest level of security and maintaining error free performance, requires detection of data integrity problems regardless of whether the goal for encryption is to thwart attacks or to promote trusted transactions. A method that is gaining popularity because of the level of its afforded security and the manner of detecting data integrity problems is “cryptography on a chip” or “COACH”. The popularity of COACH lies in the fact that from a functionality point of view, security measures can be controlled deep within each chip. Prior art also suggest ways of providing a field programmable gate array (“FPGA”) to further enhance the security and flexibility of COACH.

Commonly owned U.S. patent application Ser. No. 10/938,773 filed Sep. 10, 2004 describes a cryptographic system capable of accessing and utilizing a plurality of cryptographic engines and adaptable algorithms for controlling and utilizing those engines. That application, which is hereby incorporated by reference herein, describes the use of multiple COACH systems interacting among themselves as a group or individually, to cross check and detect data integrity problems. This enables the securing of communication between the outside world and the internals of a cryptographic system in a variety of ways such as, for example, employing a single chip which includes an FPGA to provide enhanced cryptographic functionality.

While the detecting data integrity problems is known to the prior art, improved fault isolation is needed for multi-processor systems, especially those which are required to maintain high availability. Fault isolation is necessary to pinpoint the source of a data integrity problem and remove it, so that data integrity problems do not continue to perpetuate. Consequently, an improved fault isolation mechanism is needed to determine the source of data integrity problems in multi-processor systems, especially those which include COACH chips, which mechanism can then be used to effectively isolate and remove the source of the problem.

### SUMMARY OF THE INVENTION

In accordance with an aspect of the invention, a method is provided which includes simultaneously submitting command(s) to be executed to at least two integrated circuit chips, preferably chips that support a COACH algorithm. A checksum is then generated after the command is executed by each of the chips. The resultant checksums generated from each chip are then compared and when results do not match, in one embodiment a hard error is indicated. In one or more alternative embodiments, the process is retried to ensure the problem is not due to a correctable soft error. Once a hard error is indicated the chips are fenced off and marked for replacement. In a particular embodiment, the original chips are paired off with one or more chips and process is repeated to pinpoint whether one or both chips were faulty. In as case when only one chip is found to be faulty, only that chip is fenced off.

A particular embodiment provides a method of identifying and isolating faulty components. In such embodiment, command(s) to be executed are simultaneously submitted to at least three integrated circuit chips, preferably COACH chips. After the command(s) are executed by each of the chips, their results are compared by generating a checksum. Checksums generated from each chip is compared to a second chip such that three sets of chip sets are formed. When results do not match, the process continues and the checksums are compared until another set of chips with an unmatched result is detected. In such a case the chip(s) which is common to both chip sets having the unmatched result is indicated to be a faulty chip and ultimately that chip or chips are fenced off.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a schematic illustration of a cryptographic processor chip in accordance with an embodiment of the invention;

FIG. 2 is a schematic illustrating a connection between a processor chip and an external memory in accordance with the embodiment illustrated in FIG. 1;

FIG. 3 is a diagram illustrating interconnections to a flow switch in accordance with an embodiment of the invention illustrated in FIG. 1;

FIG. 4 is a flow diagram illustrating a method of isolating a faulty processor in accordance with an embodiment of the invention;

FIG. 5 is a flow diagram illustrating a particular method of isolating a faulty processor in accordance with an embodiment of the invention;

FIG. 6 is a block diagram illustrating a system in accordance with an embodiment of the invention which includes a multi-chip unit with a plurality of processors including a spare processor; and

FIG. 7 is a block diagram illustrating a system in accordance with another embodiment of the invention which includes a multi-chip unit with a plurality of processors including a spare processor.

### DETAILED DESCRIPTION

A system and method designed to provide fault isolation and availability solutions to the problems caused by the prior art currently practiced is disclosed. The disclosed mechanism is able to provide the highest level of security (Level 4) as set out by FIPS and discussed earlier.

The embodiments of the invention herein preferably are implemented in the context of a chip system on a chip (“SOC”) or COACH encryption technology. However, they need not be used only in encryption systems or SOC system. When unnecessary to the understanding of the invention, circuit schematics and other details have also been left out in order to prevent obscuring an understanding of the present invention.

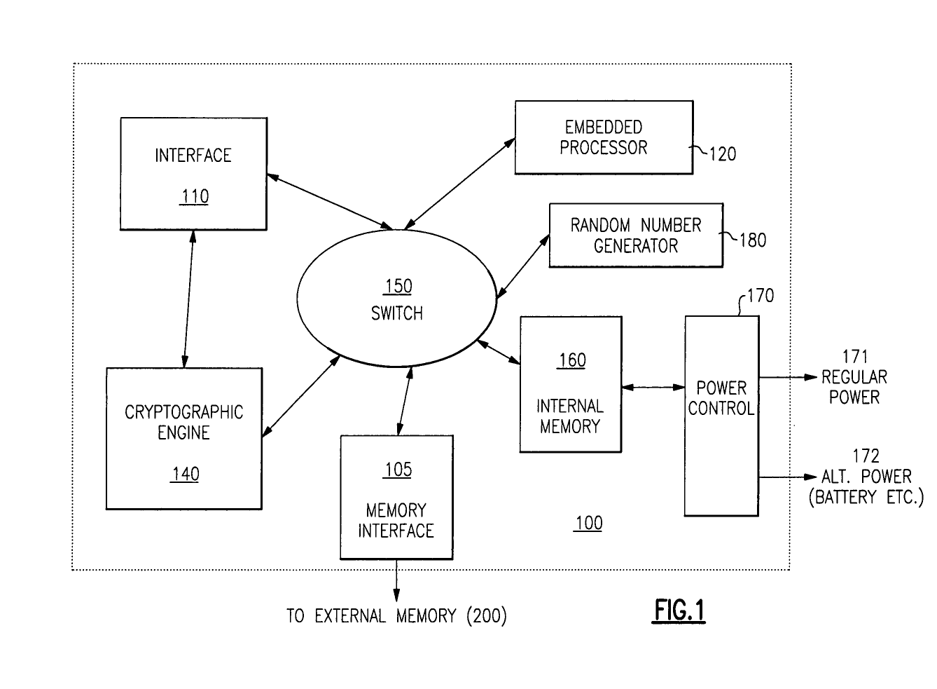

FIG. 1 is a schematic diagram illustrating a set of operational blocks within an integrated circuit or “chip” 100 functioning to perform cryptographic processing. Chip 100 is a COACH chip, utilized with other chips in performing a method of identifying and isolating faulty components in accordance with an embodiment of the invention. As implemented in a SOC in FIG. 1, each COACH chip 100 includes an embedded and secure cryptographic processor 120. Processor 120 is ensured security as it is controlled by an FPGA which is itself programmable in a secure manner. Besides the processor 120, other principal portions include interface 110, cryptographic engine 140, a random number generator 180, an external memory interface 105 and an internal memory and supporting components (160). These components 160 may include fuses, clock(s), SRAM and DRAMs among others. Preferably, such components are incorporated into the single chip 100, as illustrated in FIG. 1.

Processor 120 is preferably implemented by a processor core, such as one having general processor function and a footprint provided in accordance with a PowerPC® design, as manufactured and marketed by the assignee of the present invention. However, less complex embedded processors can be employed, if desired. While processor 120 is an embedded processor, it may or may not include internal error detection mechanisms such are typically provided by parity bits on a collection of internal or external signal lines. Therefore, it may be best to provide some form of internal error detection to increase processor reliability such that, if the processor were to fail or become defective, security measures would not be compromised.

Interface 110 is the primary port for the communication of data into chip 100. Any well-defined input output (I/O) interface may be employed. In a preferred embodiment, an I/O interface such as one in accordance with the Infiniband® or any one of several available “Peripheral Component Interconnect” (“PCI”) standards including PCI-X (“PCI-Extended”) or PCI-E (“PCI-Express”). A second interface 105 is also provided which exchanges data in a controlled fashion with external memory 200, which includes encrypted portion 210 and unencrypted portion 220, as illustrated in the schematic diagram of FIG. 2. In this way, chip 100 is provided access to external memory 200, which is preferably a random access memory (RAM) device.

Interface 110 is the primary port for communication of data and requests or commands into chip 100. Generally, the information that enters this port is encrypted. Requests for services by the chip are presented in form of request blocks which include at least one command. Typically, every portion of an entering request block, except for the command itself, comprises encrypted information. Part of the encrypted information contains a key and possibly a certificate or other indicia of authorization.

One or more cryptographic engines 140 performs encryption and decryption operations using keys supplied to it through flow control switch 150. These engines also assure that appropriate keys and certificates are present when needed. The cryptographic engine(s) 140 include specific hardware implementations of algorithms used in cryptography. Accordingly, a cryptographic chip in accordance with an embodiment of the invention has an ability to select an efficient hardware circuit efficient for encoding information.

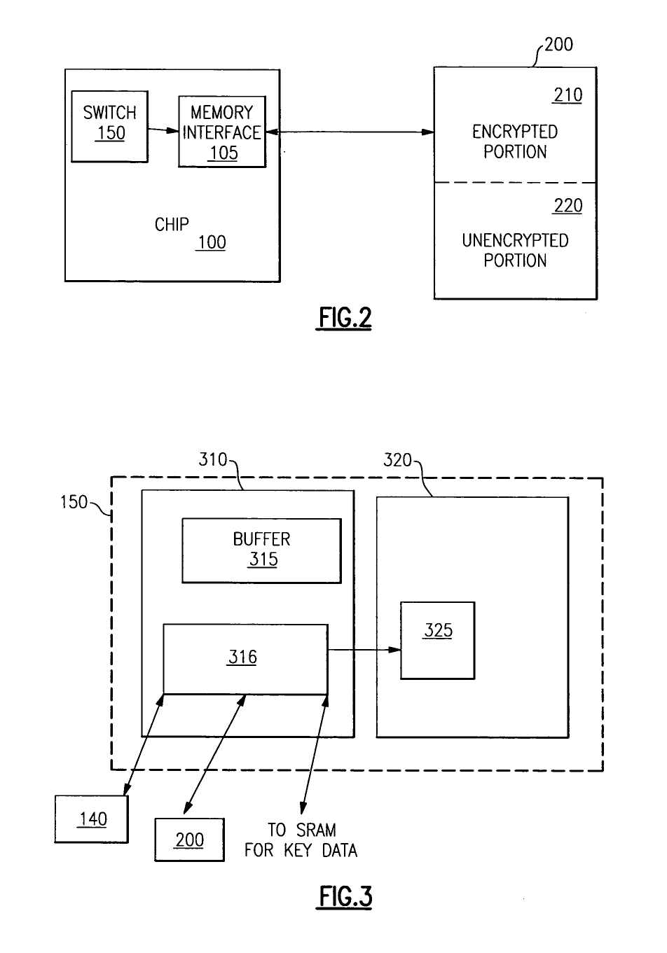

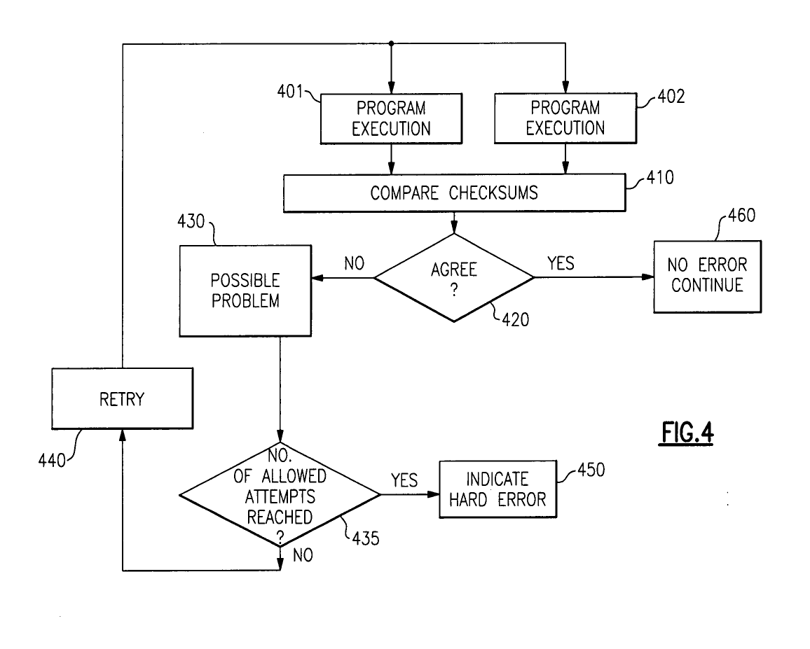

FIG. 3 provides a detailed illustration of the flow control switch 150. The flow control switch 150 receives external requests in the form of request blocks into the buffer 315 from interface 110 (FIG. 1). It can also include a request block processor 316 which receives request blocks and, in response to thereto, directs and controls the flow of information between and among the various other chip components. The switch preferably includes two components. The first one is an application specific integrated circuit (“ASIC”) 310 component portion and the second is an FPGA distinct component portion 320. The ASIC portion is used to initialize the system, to initially process request blocks, to interface with the FPGA portion and to insure that only secure FPGA information is used to configure the FPGA portion 320 of the switch 150. The FPGA portion 320 is securely configurable according to the customer's needs through internal interface 325. Illustratively, the FPGA portion is obtainable as a custom chip according to customer specifications and requirements.

Referring again to FIG. 1, the portion of an external memory (200) accessed by the chip 100 is determined by address information generated from within a secure boundary of the chip. Access to external memory 200 is through interface 105, as controlled by flow control switch 150. In a preferred embodiment, control access to external memory is provided through the FPGA portion of the switch 150. In this way, access to and from the chip is controlled through interfaces 110 and 105.

In addition to providing access to external memory 200, the primary function of the second interface 105 is to enforce addressability constraints maintained by the chip 100 in relation to an external memory 200 having two portions. In the external memory, a first portion 220 is intended to store only unencrypted information, but which is also permitted to store encrypted information. The second portion 210 is set aside for storing only encrypted information. The partition of external memory 200 into these two portions is controlled by addressability checks performed within chip 100. Such checks can be performed, for example, by the embedded processor 120 and either the ASIC portion of flow control switch or by FPGA portion. Alternatively, the checks are performed by a combination of the two. Further, the flexible nature of FPGA allows the addressability partition boundary between the two portions of external memory to be set by the chip vendor, who may or may not be the same as the chip manufacturer.

With reference to FIG. 1, power control circuitry 170 is also preferably included in each chip for controlling the distribution of power to the chip from a regular power source 171 and from an alternate power source 172, such as a battery for preserving stored data within the internal memory 160 (which is preferably implemented by an SRAM or other volatile memory). In addition, the cryptographic processor chip 100 may include other internal mechanisms such as clocks and a random number generator 180, such as used to generate random numbers used in cryptographic processes.

In a variation of the above embodiment, the functional elements of the above-described COACH chip are implemented by a group of several chips, which are mounted together in a multi-chip module (“MCM”) or other substrate, card, board, blade, or other interconnection unit which contains wiring for interconnecting the group of chips. In accordance with the embodiments described below, fault isolation is performed to isolate a failing COACH element which preferably is implemented as a SOC. However, the following embodiments are intended as well to apply when the COACH element is implemented by a group of chips. In such case, the following fault isolation procedures apply in isolating a failure to a particular group of chips that implements one COACH element, as distinguished from a different group of chips that implements a different COACH element.

One comment has to be made, however, with respect to circuitry and data encryption methodology. The economics of manufacturing semiconductor devices is driven by the amount of electronic components placed on a particular chip. This increased density affects both the surface geometry and the manner of forming electronic interconnection patterns on the chip. Frequently, the commercial success of a particular semiconductor product may hinge on the ability of the chip architect to achieve optimum chip topography. In this respect, encryption standards such as Advanced Encryption Standard (“AES”) or Triple Data Encryption Standard (“TDES”), particularly those having shorter length (128 bit) keys, are preferred.

A method of isolating a faulty processor in accordance with an embodiment of the invention will now be described with reference to FIG. 4. Such method is applied, for example, to isolating a faulty processor among a plurality of cryptographic processors such as that illustrated and described above with reference to FIG. 1. Without departing from the methods described herein or the results to be achieved thereby, each such cryptographic processor referred to in this method can be implemented in an individual chip. Alternatively, a number of such processors can be provided in a chip, or a number of chips can be utilized to implement each such processor.

Referring to FIG. 4, in such method, a command is submitted to two such processors and each processor individually then executes the command, as illustrated at blocks 401, 402. Preferably, the command is applied to each processor as a command applied simultaneously to the embedded processors 120 of two individual chips 100 through the interface 110 to the chip. Checksums are then calculated from the execution results outputted by each processor and the checksums are compared at step 410. Alternatively, in place of calculating and comparing checksums, the results of execution by each processor are hashed. Based on comparing the checksums (or hashing the results), it is determined whether the results agree or not at block 420. When the results agree, it is determined that no error has occurred, the fault isolation process need not continue any further, and operation is then allowed to continue, as indicated at block 460.

On the other hand, it is sometimes determined at block 420 that the results do not agree. In that case, it is indicated at block 430 that an error has occurred, i.e. such that a possible problem may be affecting one or both of the processors that executed the command. To further assure that such error or problem exists, preferably the same command or another command is executed by both processors to “retry” the procedure one or more times. A counter (not shown) is set to a number of allowed attempts to retry the procedure. At block 435, is it determined whether the number of allowed retry attempts has been reached. Usually, at least one retry will be performed. If on the first pass, the decision at block 435 is “No” then the procedure is scheduled to be retried, as indicated at block 440. Execution of a command by both processors and comparison of checksums or hashing of the results thereof are then performed as described above relative to blocks 401, 402, and 410. If at block 420 the checksums then match (or the hashed results indicate a match), it is determined that no hard error is present, and regular operation continues, as indicated at block 460.

However, if at block 420, the checksums do not match, then it is determined that a problem may still be present. If at block 435 it is then determined that the number of allowed attempts has been reached and the problem still persists, determination is made that a hard error has occurred, as indicated at block 450. Stated another way, a hard error is indicated when a pre-determined number of tries have been attempted without success. In that case, the chips will then be fenced off and identified as candidates for FRU replacement.

In the above description, it is assumed that the command execution and checksum comparison is retried at least once upon failure. However, in an alternative embodiment, this need not be so. In such embodiment, it may be beneficial to immediately fence both processors when the checksums do not agree on a first attempt of executing the command. In such case, both processors are preferably immediately marked as field replacement unit (FRU) candidates.

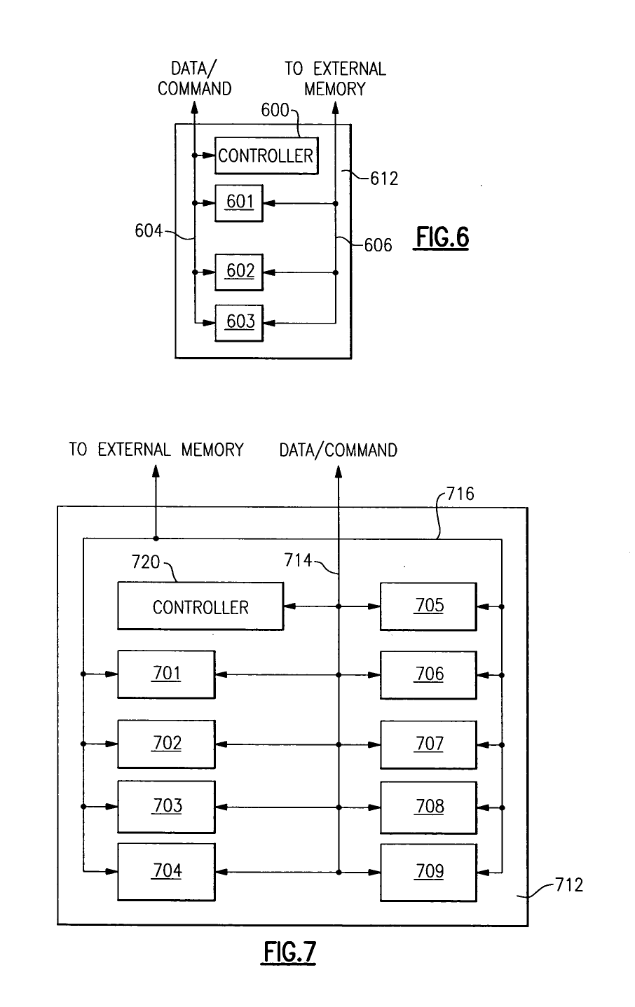

The above process has an advantage of detecting a hard error in a pair of processors to which a command is provided for execution. The pair of processors can then be fenced (removed from the system configuration) to prevent them from continuing to perform operations which might lead to data integrity problems. At that time, one or more “spare” processors can be brought online to take the place of the fenced off processors, as will be described more fully below with reference to FIGS. 6 and 7. However, a disadvantage exists in that the process does not determine which one of the pair of processors is faulty. If only one processor is faulty, it may be beneficial and economical to determine and only fence off the faulty chip while returning the functioning chip to operation.

Alternative ways are provided herein for isolating a faulty processor, e.g., processor chip or group of chips that implement such processor. In one embodiment, once the hard error is indicated, for example after the preselected number of retries has been attempted, the two chips that were originally tested in the embodiment of FIG. 4 can be each retested using the same process. In one embodiment, each of the original chips is retested sequentially with the same new chip to indicate the faulty one. In a different embodiment, each of the two original chips can be paired with other chips and retested with the other chips, such that each of the original chips is tested together with one of the new chips. The process discussed in conjunction with the embodiment of FIG. 4 will be used in each instance to isolate the faulty chip.

In a particular embodiment, the checksums or hashes of the results of executing the command are transferred between the chips through encrypted portions 210 of the external memory 200 (FIG. 2) and the comparisons are performed by the chips themselves. For example, assume that the encrypted portion of the memory includes shared memory areas for which read and write access can be assigned differently for the various chips that are permitted to use the shared memory. In a particular example, a first shared memory area provides read and write access by one chip (Chip A), and read only access by another chip (Chip B). A second shared memory area provides read and write access by Chip B and read only access by Chip A. When Chip A executes a command, it stores the checksum or hash of the result in the first shared memory area. Chip B then reads the stored checksum or hashed result from the first shared memory area. Chip B then compares the checksum or hashed result stored by Chip A with that obtained by executing the command itself. When the result of the comparison is that the two checksums or hashes agree, Chip B can then notify Chip A of the favorable result by storing the result of the comparison in the second shared memory area. In addition, if desired, Chip A can also perform the comparison of the checksums or hashed results of executing the command. In such case, Chip B stores the checksum or hashed result of executing the command in the second shared memory and Chip A reads it and compares to a result that Chip A obtains independently by executing the command.

In a variation of the above embodiment, the foregoing procedure can be used as well to isolate a fault to a processor which is implemented by a group of chips,

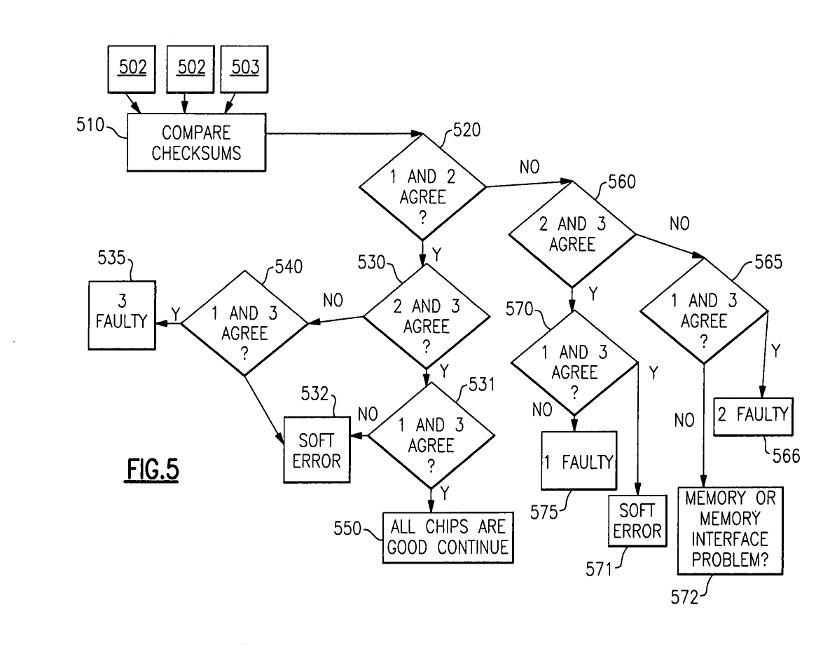

In another approach, isolation of the failing chip is performed in accordance with the flow chart illustrated in FIG. 5. In the embodiment of FIG. 5, a minimum number of three chips (as opposed to two chips used in conjunction with the embodiment of FIG. 4) are used to isolate a faulty chip from among them. When a command or other instruction is submitted to be executed, it is submitted for simultaneous execution by a plurality of processors. In the case of the embodiment having COACH chips as discussed in conjunction with FIGS. 1 through 3, the command is executed by an embedded processor 120 on each chip, each command being submitted to the respective processor through an interface 110. Command execution by each of three chips, Chip 1, Chip 2 and Chip 3 is depicted by reference blocks 501, 502 and 503, respectively, in FIG. 5. In operation, in two of the referenced blocks 501, 502, 503, two of the chips (Chip 1, Chip 2 and Chip 3), respectively, are employed to execute a command to perform one or more operations. In block 510, the results of executing the command by those two chips are compared by comparing checksums of the results for each chip, or alternatively, hashing the results of execution of each chip. Each time a command is executed, it is executed by two chips from a different pairing of the three chips.

In order to provide better understanding of this concept, assume that operation reflected by block 501 was performed by a first chip, hereinafter referenced as Chip 1. Similarly, operation indicated by block 502 is performed by a second chip, hereinafter referenced as Chip 2. The operation reflected by block 503, then necessarily is performed by a third chip that will be hereinafter referenced as Chip 3.

Chips 1 and 2 constitute a first pairing where checksums or hashes of the execution results are compared. Chips 2 and 3 will be a second pairing and checksums or hashes of their execution results are also compared. Finally, Chips 1 and 3 will be a third pairing and the checksums or hashes of their execution results are also compared. When the results of execution match in block 520, the process moves on to decision block 530 which examines the checksum or hash of the chip pairing that includes Chips 2 and 3.

If the results do not match, the results of execution by Chips 1 and 3 are examined as depicted by decision block 540. Based on that result either chip 3 is deemed faulty (block 535) or an error has occurred (block 532). However, if the results of decision block 530 produces a match, in one embodiment, it may be possible to abandon the checking as all three chips indicate regular operation. A final check can be made (block 531) to check the results of the pairing of Chips 1 and 3. It is expected that the results match in this case and the process proceeds to step 550 in such case. However, when the results do not match, a soft error or an intermittent problem is indicated and the process may be selectively retried or other similar steps taken as reflected by decision block 532.

Referring to decision block 520, again a different process path is followed when the results for Chips 1 and 2 do not match. In this case, the results of execution by Chips 2 and 3 are compared as indicated by decision block 560. If the subsequent result of this comparison step provides a match, the checksum or hash of the results of execution by Chips 1 and 3 are compared. If the result of the comparison is that Chips 1 and 3 do not match, then it is determined that Chip 1 is faulty. If the result of comparison at block 520 does not indicate a match, then the checksum or hash of the results of execution by Chips 1 and 3 are compared at block 565. When the result of that comparison is that Chips 1 and 3 match, then Chip 2 is determined to be faulty. Further, when the results of each of the three pairings produce no match in each case, it is determined that a possible problem exists in a component other than one of the chips, such that the problem is in the memory, or in the interface to the memory. It sometimes may occur that the results of comparison produce an unexpected match, such that results of execution by Chips 1 and 2 disagree, but that the results of execution by Chips 2 and 3 agree and by Chips 1 and 3 agree. In such case, it is determined that a different condition may have occurred, such as a soft error. When there are more than three chips, the process can be retried by other combinations of chips. For example, when there are four chips, the process can be retried by other pairings including the fourth chip together with one of the first, second or third chip, and then comparing the checksums or hashed results of those further retry processes.

However, when there are a large number chips, preferably the above process is performed only a limited number of times. This avoids continuing to retry the process via different pairings when continuing to test in such manner would provide no further benefit. Preferably a threshold or limit is set in the computing system, for example, by way of system hardware or firmware. Once the above process has been retried the number of times defined by the limit, the retrying process terminates, even if no successful pairing of chips has yet been identified. One way that the limit may be implemented is at boundaries between different groups of chips included in the computing system. Thus, the limit may be defined to coincide with the number of chips within each group such that the limit is exceeded when all of the different pairings among the chips within a particular group of the chips have been tried without success. Once the limit is reached, it is concluded that any effort to isolate the failure requires different testing. The response may involve taking the whole group of chips offline when it appears that the chips of that group cannot be assured to operate successfully, in a manner as appears in the following description.

In a particular embodiment, testing which verifies continued operation of the computing system is performed at a different time from other testing which is used for fault isolation. The example described above with respect to FIG. 5 details a procedure for isolating a failing chip among a group of chips, e.g., three or more chips. When a failure is due to a problem caused by a single chip, the above-described process isolates the problem to that one chip, so that processing can continue with other chips despite that failed chip. However, the failure isolation process takes time to perform. Sometimes, when the computing system is being operated at or near maximum capacity, performing failure isolation using different pairings of chips can interfere with the work that needs to be performed by the chips. Other times, a problem may exist only with respect to a particular pairing of chips, and not other pairings. In such case, each of the particular chips in the failing pair tests correctly when such chip is paired with another chip. The problem in such case may be a “soft” problem relating to the way that signals travel between chips in those pairings which fail. Frequently, a soft problem is attributable to a memory element, such as, for example, the external memory 200 or internal memory 160.

In light of these scenarios, testing can be performed in stages such that when the chip and other such chips are busy performing their primary work, only minimal testing is performed. For example, according to the above example, when an error is indicated as possibly originating from a particular chip, the above-described testing can be performed to try a command submitted to that chip and one other chip. When such testing indicates failure, the command can then be tried with the particular chip and a third chip. At that point, if the results of the execution are successful on both the original chip and the third chip, then no further testing in that manner is performed. However, the failure will not have been isolated yet. Further testing would be needed to retry the command by a pairing between the second chip and third chip.

In this case, whenever possible, the further testing needed to isolate the failure is not performed when the computing system is being operated in its normal operational mode. Instead, the failure and the information derived from testing the two pairings of the chips to that point are logged at that time. Further testing to isolate the failure is postponed until a later time when the computing system is less busy and can afford the time that is required. In one example, the failure isolation can be postponed until the computing system, or a portion of the computing system enters a “maintenance mode” and the like. At such time, the maintenance mode can be entered and failure isolation be performed with respect to the computing system as a whole. Alternatively, the maintenance mode can be entered and failure isolation be performed as to a portion of the computing system, such as a multi-chip unit 712 (FIG. 7) including several chips, as described below, or failure isolation can be performed as to a group of chips on such multi-chip unit.

FIG. 6 is a block diagram illustrating a multi-chip unit of a computing system in accordance with another embodiment of the invention. Such multi-chip unit, which can take the form of a “blade” element of a computing system, a circuit board, circuit card, multi-chip module (“MCM”), substrate, or other such unit, preferably is a modular unit which can be used in a computing system together with other like units. In the following description, the term “multi-chip unit” is used to refer to any and all such blade unit, circuit board, circuit card, multi-chip module (“MCM”), substrate, or other unit which contains a plurality of processors, for example, COACH processors, regardless of the particular form that it takes. The multi-chip unit preferably is addable, insertable and removable from the computing system, in accordance with upgrades, repairs, and/or configuration changes to the computing system. In one embodiment illustrated in FIG. 6, a multi-chip unit 612 includes three COACH elements 601, 602, and 603, each of which is implemented as a SOC, in the manner described above with reference to FIG. 1. Thus, in this embodiment, each COACH element is implemented by a single chip. The three processor chips 601, 602, and 603 are all connected to receive data and commands through an I/O bus referenced as 604. The three processor chips 601, 602 and 603 are also connected to an external memory though another bus 606 for that purpose. A controller 600, having functions described below, can be mounted within or on the multi-chip unit or be mounted to another element of a system to which the multi-chip unit is connected.

The controller 600 functions, in a test mode, for example, to submit a command to two processors simultaneously and checking the results of execution by the two processors. One or more of the chips on the multi-chip unit can be online at any given time, i.e., operational and assigned to executing commands. On the other hand, at any given time, one or more of the chips can be offline, that is not operational and not assigned to executing any commands. Controller 600 can take one COACH chip offline that is failing and bring a different online in its place. For example, a particular chip 603 can be normally offline. When the fault isolation procedure described above with reference to FIGS. 4-5 determines that a chip 601 is failing, the controller takes chip 601 offline and brings chip 603 online in its place.

In a variation of the above-described embodiment, the controller 600 does not compare the checksums or hashes of the results of execution by the pairs of chips. Instead, a procedure is followed such as that described above with reference to FIG. 4 in which at least one chip in each pairing of chips stores the checksum or hash of the result in an area of shared memory and the other chip in such pairing obtains the stored checksum or hash and compares it to the checksum or hash obtained by itself.

In a variation of the above embodiment, each of the COACH elements 601, 602, 603 in the multi-chip unit is implemented by a plurality of chips. In such case, the above operations are performed such that a failing one of the COACH elements is taken offline and a spare COACH element is brought online, although each such COACH element includes a plurality of chips.

FIG. 7 illustrates a variation of the embodiment illustrated in FIG. 6 in which nine processors, for example COACH elements 701, 702, 703, 704, 705, 706, 707, 708 and 709 are mounted to one multi-chip unit 712, each of the processors preferably being implemented as a SOC on a single chip and being connected for receipt of and outputting of data and commands through an input output (“I/O”) bus 714 to a controller 720 and through an interface 716 to an external memory. The multi-chip unit illustrated in FIG. 7 differs from that shown in FIG. 6 in that nine chips are provided, one of which is normally offline, instead of three. Having nine chips, a greater efficiency of operation is achieved because the ratio of normally offline chips to online chips is 1:8. This ratio is much smaller than the corresponding 1:2 ratio achieved for the multi-chip unit illustrated in FIG. 6. In addition, having a greater number of chips available as included in the multi-chip unit allows fault isolation to be carried out to a greater degree than in the example illustrated in FIG. 6. Further, in the embodiment illustrated in FIG. 7, the number of online chips to offline chips can be adjusted as needed, in accordance with control operations effected by the controller 720.

With the greater number of chips available on multi-chip unit 712 than on multi-chip unit 612 (FIG. 6), it is possible to divide the chips of the multi-chip unit 712 into groups, preferably via hardware or firmware. A limit is then defined according to the number of chips in each group. Following the test method described above with reference to FIG. 4, the test is retried a maximum number of times, the maximum number equaling the maximum number of chips in the group.

In one example, two groups of four chips can be defined among the eight normally online chips 701 through 708 that exist on the multi-chip unit 712. For example, through firmware the eight chips can be divided into a Group A having four chips 701 through 704 and Group B having another four chips 705 through 708. One other chip 709 may be reserved as a backup chip to be brought online in case an individual one of the other chips needs to be taken offline.

Alternatively, through firmware it is possible to define the chips 701 through 709 on multi-chip unit 712 into three groups of three chips each, instead of two groups of four chips. Then, it can be defined that one Group I of the chips includes the chips 701 through 703, Group II includes the chips 704 through 706 and a Group III of the chips includes the chips 707 through 709.

When no successful pairing of chips is identified among the chips in a group, for example, among the chips of Group A containing four chips, it is concluded that the group of chips is failing, and such group is taken offline. This could happen if a problem affects all of the chips of the group, such problem being a hardware, software or memory problem or problem related to an interface or communication link, for example. However, in such case, when the other group of chips (Group B) does not share the same elements of the system that are involved in the problem, the Group A chips can be taken offline while allowing the Group B chips to continue operating.

In a particular variant of the above embodiment, whenever the comparison of the checksums or hashed results fail for a pairing of the chips, the result of the failing comparison is reported to the computing system. Specifically, the failing result can be reported to a supervisory element of the computing system such as an operating system or a super-privileged element such as a hypervisor which provides services to the operating system. The operating system or hypervisor can then respond by avoiding commands from being simultaneously submitted to the two chips for which the comparison failed. Different pairings will be used instead. For example, if the comparison of the checksums or hashed results between two individual Chips A and B fails, but the comparison succeeds for two individual Chips B and C, then subsequent testing avoids comparing the checksums or hashed results for the Chips A and B. When the computing system is relatively busy in normal operation, no attempt is made at the time to isolate the problem at the time when the problem is first reported. The operating system or hypervisor addresses the problem at some later point, such as when the computing system enters a maintenance mode at a point in time when the computing system is less busy.

In another variation of the above embodiment, it sometimes happens that the comparison for a certain pair of chips such as Chips C and D fails only when executing a particular command, but not when executing other commands. In such case, testing using that particular command is avoided when testing Chips C and D. However, other testing using other commands can be performed for that pair of chips. As in the above case, further testing to isolate the failure to a particular chip or other element is postponed until a later time when the computing system can afford to allocate the time and resources, e.g., the chip quantities to operate in a maintenance mode and to diagnose the problem.

In a particular variation of the above-described embodiment, the allocation of chips on a multi-chip unit (712; FIG. 7) for use in regular operation or as spare chips is not permanently fixed. Rather, for a given number of chips in a multi-chip unit, the number of chips allocated to regular operation and as spare chips is controlled by firmware which is subject to change according to a customer's requirements. For example, for a multi-chip unit 712 having nine available chips, the chips can be allocated in various ways depending upon the customer's needs for performance and availability. Thus, the chips can be allocated with eight chips for normal operation and one chip as a spare when a particular customer has a need for high peak performance. The one chip allocated as a spare is available for use if any of the other eight chips needs to be taken offline in case of failed testing. On the other hand, when the customer has a greater need to assure the availability of the computing system, two chips may be then allocated as spare chips, and the remaining seven be allocated for normal operation. In yet another alternative, to suit another customer's needs, all nine chips can be allocated for normal operation and then no chips be allocated as spare chips, when the customer has a greater need for peak performance than for availability.

As in the example above, in a variation of the above embodiment, each of the nine COACH elements 701, 702, 703, 704, 705, 706, 707, 708 and 709 in the multi-chip unit is implemented by a plurality of chips. In such case, the above operations are performed such that a failing one of the COACH elements is taken offline and a spare COACH element is brought online, although each such COACH element includes a plurality of chips.

This embodiment can be further enhanced by allocating the number of chips to the uses needed and requested by the customer, regardless of the number of chips which are available on the multi-chip unit. Specifically, for a multi-chip unit on which a certain number of chips are present, the customer's desires and needs are used to decide the number of chips to be allocated to normal operation and the number allocated as spare chips. Thus, it is possible for multi-chip units which contain nine chips to serve customers who have lower performance requirements, and also serve other customers who have higher performance requirements. Specifically, in order to acquire certain function at a lower cost, a customer can decide to utilize only a few chips on the nine chip multi-chip unit. In such case, hardware or firmware settings can be used to configure the multi-chip unit to utilize only the number of chips that the customer contracts with the manufacturer to use. For example, the customer can contract to use four chips for normal operation and one spare chip. In another case, when the customer contracts for a greater amount of performance and/or availability, firmware settings are used to configure a greater number of chips, e.g., all nine chips, for use in operation and as a spare chip.

While the invention has been described in accordance with certain preferred embodiments thereof, many modifications and enhancements can be made thereto without departing from the true scope and spirit of the invention, which is limited only by the claims appended below.

What is claimed is:

1. A method of identifying a defective processor of a plurality of processors of a multi-processor system, comprising:
(a) submitting a first command to a first processor and a second processor of a plurality of processors within a multi-processor system;
(b) executing the first command by each of the first and second processors;
(c) comparing a first result of executing the first command by the first processor with a second result of executing the second command by the second processor; and
(d) indicating an error when the step of comparing indicates that the first result does not match the second result.

2. The method as claimed in claim 1, further comprising, when the first result, performing a step (e) of repeating a predetermined number of times the sequence of steps (a) though (d) and when said error is indicated each time, indicating a hard error.

3. The method as claimed in claim 1, further comprising, upon indicating the hard error, fencing the first and second processors from a remaining portion of the multi-processor system.

4. The method as claimed in claim 3 wherein two other processors can be brought online once a hard error has been indicated and said original first and second processors have been fenced off.

5. The method as claimed in claim 1, wherein the first and second processors are provided on first and second individual chips, respectively, each of the first and second processors and each of the first and second chips being operable to perform cryptographic processing, wherein said first command includes an instruction to perform at least one of an encryption operation or a decryption operation.

6. The method as claimed in claim 1, further comprising isolating the hard error to a faulty one of the first and second processors by steps including:
submitting a second command to a third processor;
submitting the second command to the first processor;
executing the second command by the first processor and by the third processor;
comparing a result of executing the second command by the third processor with a result of executing the second command by the first processor;
submitting a third command to a third processor;
submitting the third command to the second processor;
executing the third command by the third processor and by the second processor;
comparing a result of executing the third command by the third processor with a result of executing the third command by the second processor; and
isolating one of the first and second processors as faulty when outcomes of comparing the results of executing the first, second and third commands by the one processor with the results of executing such commands by others of the first, second and third processors are that the results do not match.

7. The method of claim 6 further comprising taking the isolated faulty processor offline and brining online a different processor in place of said isolated faulty processor that has been taken offline.

8. The method as claimed in claim 6, wherein after isolating the faulty one of the first and second processors, removing the faulty one of the first and second processors from the active system configuration and utilizing the third processor in place of the faulty processor.

9. The method as claimed in claim 8, further comprising submitting a fourth command to a fourth processor;
submitting the fourth command to a processor selected from the group consisting of the first, second and third processors;
executing the fourth command by the fourth processor and by the selected processor;
comparing a result of executing the fourth command by the fourth processor with a result of executing the fourth command by the selected processor; and
when none of the results of executing the first, second, third and fourth commands by any of the first, second, third and fourth processors match any other results of executing the first, second, third and fourth commands by any of the first, second, third and fourth processors, isolating a fault to an element other than one of the first, second, third and fourth processors.

10. The method as claimed in claim 8, wherein the first, second and third processors are provided on first, second and third individual chips, respectively, each of the first, second and third processors and each of the first, second and third chips are operable to perform cryptographic processing, wherein the step of removing the faulty one of the first and second processors includes removing a faulty one of the individual chips from the active system configuration and the step of utilizing the third processor includes placing into the active system configuration the third chip in place of the faulty one of the individual chips.

11. The method as claimed in claim 8, wherein the first command is simultaneously executed by each of the first and second processors, the second command is simultaneously executed by each of the first and third processors and the third command is simultaneously executed by each of the second and third processors.

12. The method as claimed in claim 8, wherein the steps of comparing the results of executing the first, second and third commands by ones of the first, second and third processors includes generating a checksum for each of the results and determining whether the corresponding checksums match.

13. The method as claimed in claim 8, wherein the steps of comparing the results of executing the first, second and third commands by ones of the first, second and third processors includes generating a hash of each of the results and determining whether the corresponding hashes match.

14. A processing system, comprising:
at least a first processor and a second processor;
a controller operable to submit a command to the first and second processors for execution and to compare a result of executing the command by each of the first and second processors,
wherein the controller is operable to submit a first command to each of the first and second processors, each of the first and second processors is operable to execute the first command, and the controller is further operable to compare a first result of executing the first command by the first processor with a second result of executing the second command by the second processor and to indicate a hard error when the first result does not match the second result.

15. The processing system as claimed in claim 14, further comprising, wherein when said step of comparing indicates that the first result does not match the second result, the controller is further operable to submit the first command to the first and second processors for execution a predetermined number of times and to compare the first result to the second result produced each by the first and second processors each of the predetermined number of times, and to indicate the hard error when the first result does not match the second result each of the predetermined number of times.

16. The processing system as claimed in claim 15, wherein the controller is further operable upon indicating the hard error to fence the first arid second processors from a remaining portion of the multi-processor system.

17. The processing system as claimed in claim 15, wherein the first and second processors are provided on first and second individual chips, respectively, and each of the first and second processors and each of the first and second chips are operable to perform cryptographic processing.

18. The processing system as claimed in claim 15, further comprising: a third processor, wherein the controller is further operable to submit a second command to the first processor and to the third processor for execution by the first and third processors, respectively, and to compare a result of executing the second command by the third processor with a result of executing the second command by the first processor, the controller being further operable to submit a third command to the second processor and to the third processor for execution by the second and third processors, respectively, and to compare a result of executing the third command by the third processor with a result of executing the third command by the second processor, such that the controller is operable to isolate one of the first and second processors as faulty when outcomes of comparing the result of executing the first, second and third commands by the one processor with the result of executing such commands by others of the first, second and third processors are that the results do not match.

19. The processing system as claimed in claim 18, wherein the controller is operable after isolating the faulty one of the first and second processors to remove the faulty one of the first and second processors from the active system configuration and to place the third processor into the active system configuration in place of the isolated faulty one of the first and second processors.

20. The processing system as claimed in claim 19, further comprising a fourth processor, wherein the controller is further operable to submit a fourth command for execution to the fourth processor and to a processor selected from the group consisting of the first, second and third processors and to compare a result of executing the fourth command by the fourth processor with a result of executing the fourth command by the selected processor, such that when none of the results of executing the first, second, third and fourth commands by any of the first, second, third and fourth processors match any other results of executing the first, second, third and fourth commands by any of the first, second, third and fourth processors, the controller is operable to isolate a fault to an element other than one of the first, second, third and fourth processors.

21. The processing system as claimed in claim 19, wherein the first, second and third processors are provided on first, second and third individual chips, respectively, each of the first, second and third processors and each of the first, second and third individual chips being operable to perform cryptographic processing, wherein the controller is operable to remove a faulty one of the individual chips from the active system configuration when the fault is isolated to a corresponding one of the first, second and third processors and the controller is operable to place into the active system configuration the third chip in place of the faulty one of the individual chips.

22. The processing system as claimed in claim 19, wherein the first and second processors are operable to execute the first command simultaneously, the first and third processors are operable to execute the second command simultaneously and the second and third processors are operable to execute the third command simultaneously.

23. The processing system as claimed in claim 19, wherein the ones of the first, second and third processors are operable to generate a checksum for each of the results of executing the corresponding ones of the first, second and third commands and to determine whether the corresponding checksums match.

24. The processing system as claimed in claim 19, wherein the ones of the first, second and third processors are operable to generate a hash of each of the results of executing the corresponding ones of the first, second and third commands and to determine whether the corresponding hashes match.
